(19) United States
(12) Patent Application Publication
(10) Pub. No.: US 2008/0237558 A1
(43) Pub. Date: Oct. 2, 2008

(54) Electric Fence Tape and Method of Weaving and Installing

(76) Inventors: Jeff A. Jensen, Marysville, WA (US); Edwin Vyhmeister, Woodway, WA (US)

Correspondence Address: JEFF JENSEN, 5707 69TH AVE., NE, MARYSVILLE, WA, 98270, US

(21) Appl. No.: 11/695,589

(22) Filed: Apr. 2, 2007

(51) Int. Cl. A01K 3/00; H05C 1/06

(52) U.S. Cl. 256/10; 119/712

(57) ABSTRACT

An interwoven, adhesive backed, electric fence barrier ribbon and tape and a method of weaving thereof. The present invention discloses a fully self contained electric fencing system that is adaptable to many conditions and one that does not require a ground rod or any special soil conditions to operate. The invention accomplishes this by providing two different groups of conductors, each being electrically potentially different from the other and all weaved within the same tape for use with high voltage or low voltage systems. The invention also provides for an efficient and cost effective system to mass produce the product and further more it can be produced in a multitude of color coordinated choices as set forth in the following specifications.

Objects and Advantages:

The configuration of this design allows for the mass production of this invention with a very cost effective system using tools and machinery that are commonly known to those in this field.

It is an object of this invention to provide a strong, adaptable, abrasion resistant, weatherproof, UV resistant, corrosion resistant and flexible in all temperatures electrical fencing system that has an adhesive backing that is water proof and durable that adheres fast and conveniently to most common surfaces, has sufficient conductivity to maintain desired voltages along the entire length, resist wear and tear, be easy to install and maintain and more specifically be adaptable to work equally well on slugs, snails, birds, rodents, dogs, cats, horses, cattle, deer, elk, livestock, wild animals and pest of all sizes and types and work with low, medium or high voltages, work with both AC or DC currents, not require a grounding system where the animal needs to complete a circuit to earth in order to receive the desired electrical shock, be available with varied power supplies to match the desired animal in need of control, be flame resistant, offer improved safety for use around children and pets, be lightweight and easy to mass produce in a cost effective manor, come available in many different designer colors, be splice-able and have easy and simple electrical connections.

### SUMMARY OF THE INVENTION

Our invention offers many advantages over the prior art as described.

### DESCRIPTION

The electric fence system of this invention comprises several components that interrelate to form a system that offers adaptability that will provide protection from creatures as small as a slug to animals as large as a bull and flexibility that makes it easy to install and in more selected areas and also provides better safety and improved efficiencies.

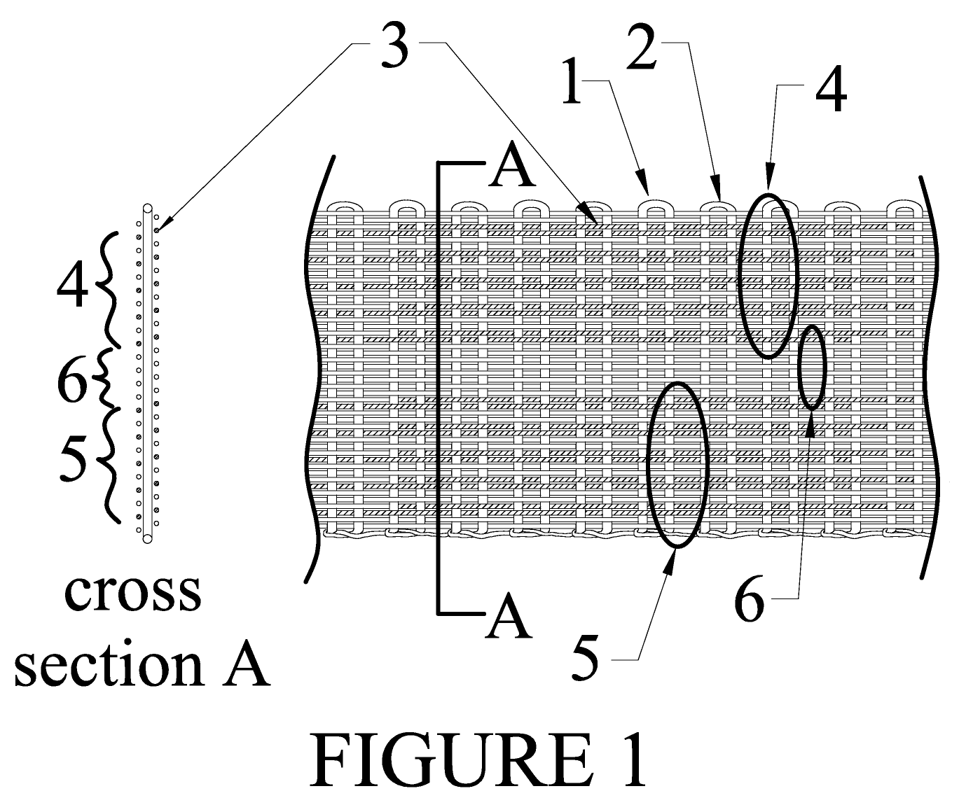

The electric fence tape (1) of this present invention consists of multiple interwoven plastic threads (2) laced with one or a number of electrically conductive threads (3) running parallel with each other and longitudinally with the tape. In the top view, FIG. 1, the drawing disclosures and illustrates details of two separate bands or groups of the electrically conductive threads (4 and 5) running parallel to each other and separated by a precisely measured, non-conductive, water shedding insulating gap (6). The actual numbers, sizes and spacing of the conductors (3) and the size and configuration of the insulating gap (6) between the two oppositely electrically biased sides (4 and 5) will vary depending on the size and type of the creatures desired to control. For example, the smaller creatures such as a snail will require a smaller gauge of conductor and a smaller insulating gap at a lower voltage, while a larger creature such as a horse will require a larger gauge of conductor and a larger insulating gap at a higher voltage. The two bands of electrical conductors (4 and 5) will each be electrically potentially different from the other. One band of conductive threads on one side of the tape (4) is designed to be the positive in a DC charged system or electrically charged hot side in an AC charged system while the opposite band of conductive threads (5) will be the negative or ground. The electrically conducting threads (3) have been interwoven with plastic threads (2) in such a manor as to expose the laces and surfaces of said conductive threads to the surface of the ribbon in a comprehensive and full coverage pattern whereby any creature whether it is as small as a slug or snail or as large as a horse cannot crawl over the surface or touch the surface of said tape with out touching both bands of conductive threads (4 and 5) simultaneously, the positively charged and the negative or ground, thereby completing an simple electric circuit and receiving a prescribed electrical shock which will inhibit them from either crossing over the tape or wanting to touch it again. It is also noted that the design of tape will be very flexible to allow it to wrap tight around 90 plus degree corners without breaking.

Additionally, the electric fence ribbon of this invention will be constructed of UV resistant, fire resistant, weatherproof, abrasion resistant, durable, strong and lightweight plastic threads produced in a multitude of complementing colors that have low stretch or elongation. The type, size and quantity of the conductors used will be determined by the type and size of the creature desired to control. For example, a very durable and heavier gauge superior stainless steel conductor with superior tensile strength and high conductivity will be desired for use around large livestock or a lighter gauge aluminum maybe selected for controlling rodents or birds for instance. The chosen conductors in all instances will be lightweight, durable, corrosion resistant, highly conductive, strong, break resistant and wear and abrasion resistant. The stretch ability or elongation of the conductors will be engineered to match the same elongation properties of the plastic threads to eliminate breakage of the threads and conductors. Coating materials to improve functionality and durability could be applied to the threads and or conductors of the ribbon depending on the materials used in its construction and the particular models intended purpose. These coating materials maybe used to improve the corrosion resistance of an aluminum conductor or the abrasion resistance of the plastic threads or the water shedding capabilities of the entire assembly for instance.

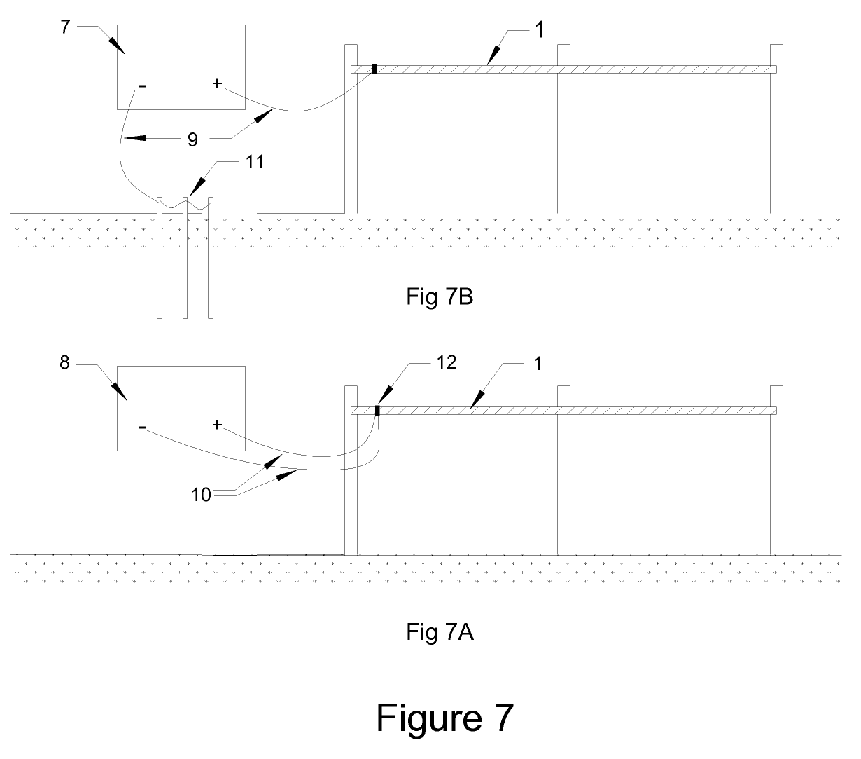

The electrical fence system of this invention can be energized using AC or DC current (FIG. 7) and charged with a high voltage, medium voltage or a low voltage depending on the type and size of the creatures that you desire to control and the level of safety you want to employ. This makes the system very versatile so that it can be used to control small, medium or large animals.

The two parallel electrical conductor(s) (4 and 5) will each be energized or connected to their designated power sources as illustrated in FIG. 7 and utilizing a special clip (12) that provides the biased electrical energies to the two opposing sides of the tape.

When this invention is utilized as a high voltage AC system, which is used to control large animals such as horses, the power supplies used are the exact models used for plastic ribbon electric fences available by the retail electric fence industry today. These readily available retail power supplies can be purchased to offer many different benefits such as pulsed energy charges, energy conservation and different safety features as well. The size and type desired will be determined by the end user as defined by their individual goals and desires as any of the models we know of can be adapted to work with the electric fence ribbon as claimed in this invention. These AC power supplies are connected different however (FIG. 7A) as no system ground (FIG. 7B item 11) will be required to provide the shock to the animals. Individual building codes and safety requirements may require such a ground, but the ground is not required for the electric fence system to deliver its shock to the animal. The grounding conductor side of the ribbon (5) is connected to the ground of the power supply (8) and the energized side of the ribbon (4) is connected to the energized or hot terminal of the power supply (8) thereby creating an energized and biased circuit along the entire length of the electric fence ribbon that is only shorted or closed when an animal touches both sides of the tape (4 and 5) simultaneously. This electrical shock will occur regardless of the soils electrical conductivity and earth to ground conditions because the design permits the electrical circuit to be completed within the electric fence ribbon itself instead of relying on the circuit to be completed by creating a path for the electricity to flow through the body of the animal to earth ground.

When this invention is utilized as a low to medium voltage system it is typically energized with a DC power supply (8). The DC system differs from the AC system described above only with the type and amount of energy used to energize the electric fence and provide the desired level of shock to the animal. The DC power supplies are typically used for the medium to low voltage systems where control of smaller creatures and animals is desired. The desired voltage and amount of current needed is determined and engineered to meet the desired shock levels to control the animals in question. Very safe voltage levels such as 6 volts DC and very small currents can be employed to control small pests such as slugs and snails while larger charges will be required to control rodents, birds and other small animals. The electric fence ribbon is sized appropriately and designed to handle the appropriate level of energy needed and it is connected to the power supply (8) in the same manor as the AC system (FIG. 7A) using clip (12) and the shock is delivered in the same manor and function without needing a good connection to earth ground.

By changing the type, level and amount of energy applied to the electric fence ribbon it can be adapted to meet the needs of practically any animal control situation.

The power supplies are connected to the two separate bands of conductive threads (4 and 5) via a plastic clip (12) that is clamped around the tape. This clip has two separate conductive contacts, one is connected to the positively charged or hot terminal of the power source and the other to negative or ground (10) via a two conductor wire and said clip is sized appropriately so that each conductive contact aligns with its separate band of conductive threads and maintains complete insulation between the two sides (4 and 5) so as not to cause an electrical short circuit. The same clip (12) can also be used to electrically join and mechanically fasten 2 or more separate electric fence ribbons end to end to increase the length by simply over lapping the last inch of these two separate ribbons and laying the ends of two tapes, one directly on top of the other and applying clip (12) to secure them together and make the necessary electrical bond.

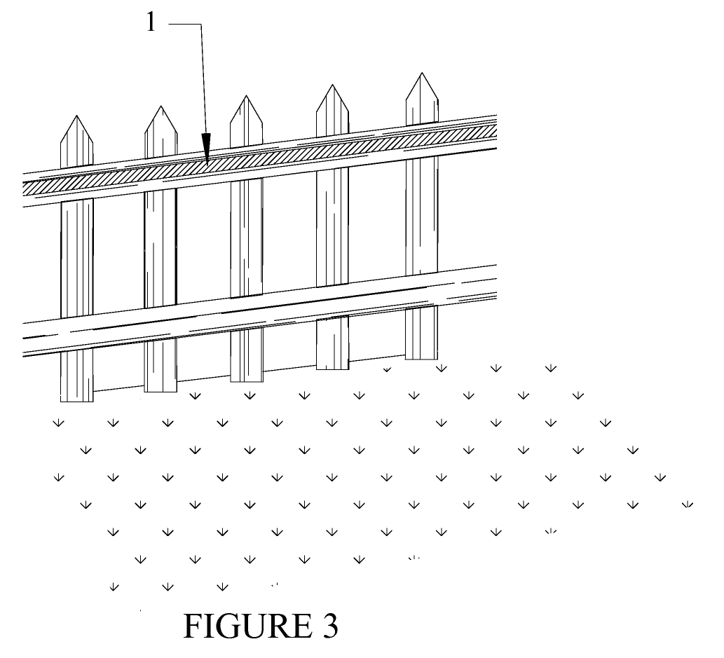

The claimed invention also includes producing the tape in a multitude of colors to compliment the surface or surroundings it is applied to. For example and to illustrate the benefit of supplying the tape in different colors, at the discretion of the end user they could apply a tan tape to camouflage or to minimize the visual impact on a wooden fence as shown in FIG. 3 or they could apply a red tape as a highlighted stripe and to bring attention to the electrically charged tape for safety purposes. Additional examples of the benefits of having multiple colors available can be illustrated by following the low voltage DC embodiment used to control slugs and snails. An end user could install a blue colored 6 volt DC electric fence, adhesively applied around a blue flower pot for esthetic purposes. This would provide a color coordinated and attractive electric fence perimeter around their flower pot offering an attractive alternative for protection from slugs and snails.

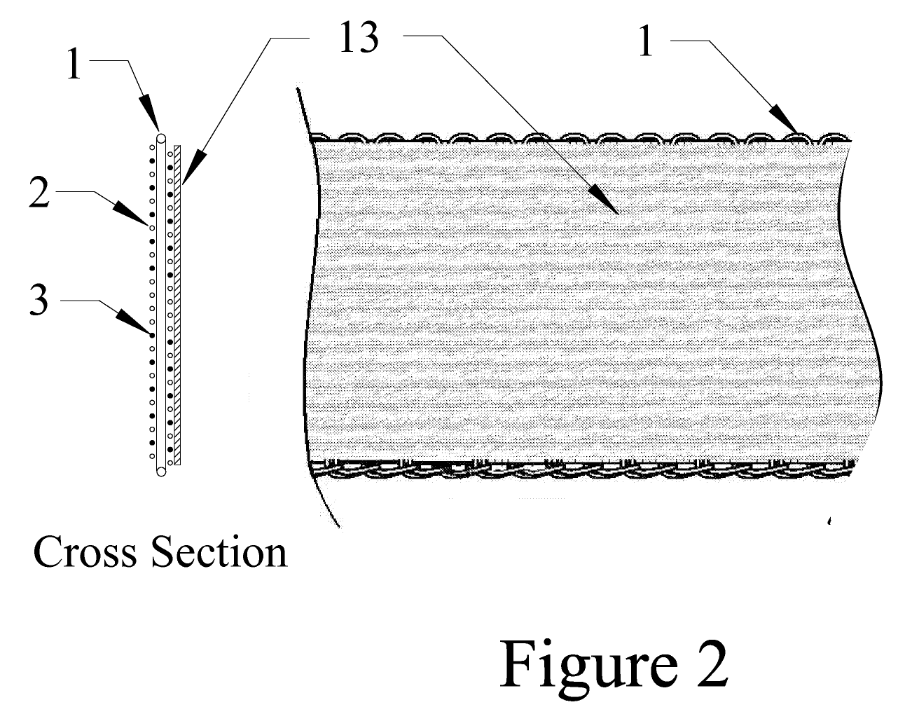

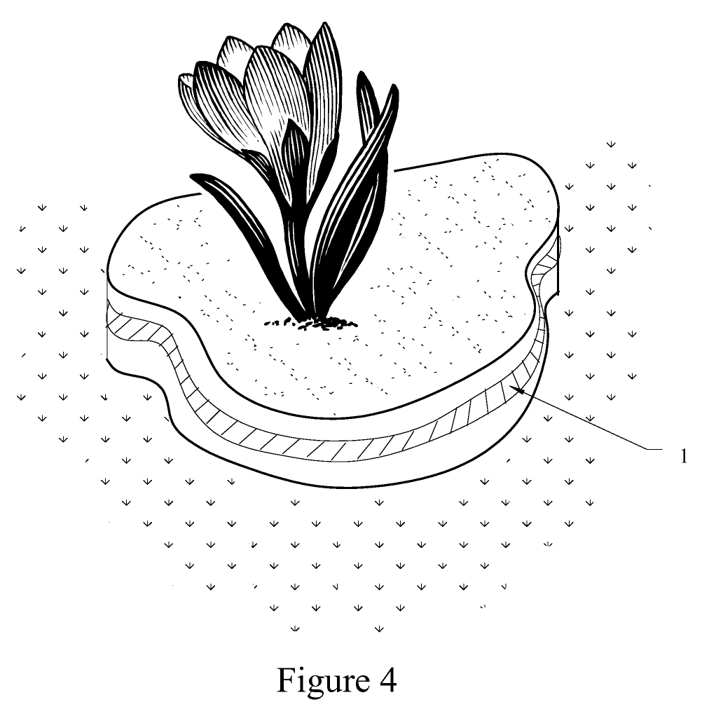

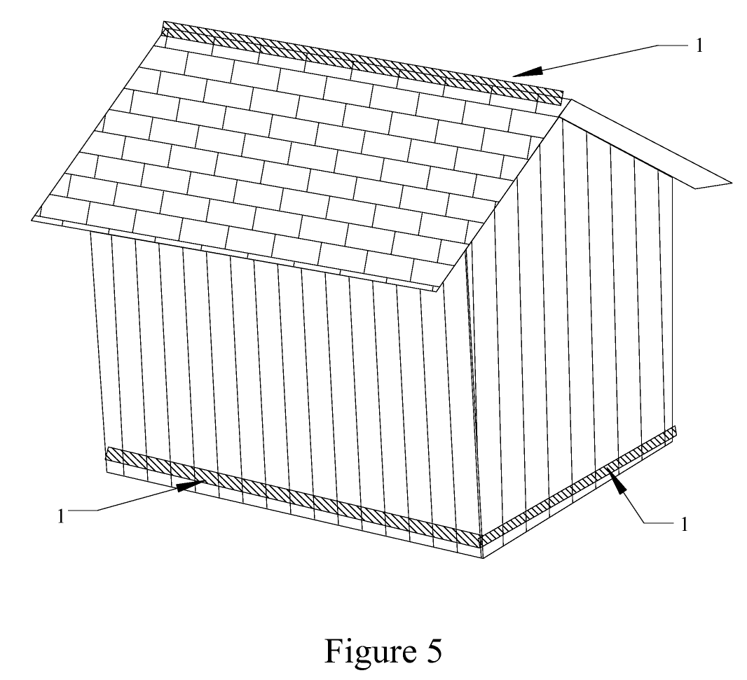

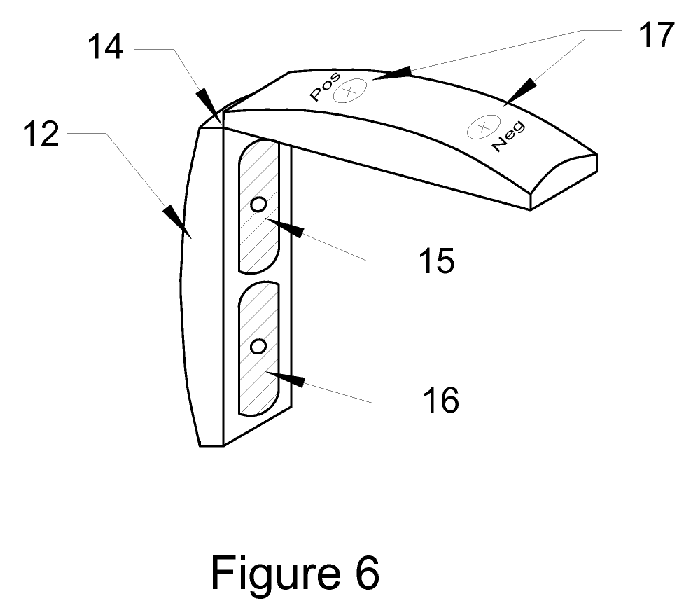

The claimed invention also includes a unique way of mounting the electric fence ribbon to many different surfaces as we touched on in the preceding paragraph using the blue flower pot as an example. By supplying the tape with a weather proof and electrically insulating adhesive backing (FIG. 2 item 13) as another option the electric fence can be adhered to many different selected surfaces which increases the ease of installation, adaptability and functionality of the invention. For example, using the adhesive backing, the electric fence tape can be applied to the surface of many different types of garden edging (FIG. 4). This application or embodiment, coupled with the low voltage DC power supply and using a green or black colored ribbon can provide a very versatile, attractive, safe, easy to install and cost effective system of controlling garden pests such as slugs and snails. Another example embodiment of the tape application would be to apply the electric fence ribbon to the peak or eave of a roof top (FIG. 5). This application, coupled with the medium DC voltage power supply and using a color to match the roof top will provide a very effective, attractive, safe, versatile, cost effective and easy to install system of controlling pigeons, seagulls and the like. And another example of using this invention would be to use the adhesive backing to apply it to the lower surface of a wall surrounding a storage shed (FIG. 5). This application coupled with a medium voltage DC power supply and a colored ribbon to match the painted surface of the shed can also offer a very attractive and safe system of controlling rodents, cats or dogs from burrowing under or into the storage shed. And to further illustrate the full adaptability and versatility of this system as described, the electric fence ribbon can also be installed in the exact same manor as the typical electric fence systems (FIG. 7) and simply mounted using typical electric fence brackets and clips to posts around a farm with the added benefit of not needing ideal soil or grounding conditions.

Our invention resides not only in any one of these features per se, but rather in the particular combination of all features herein disclosed, illustrated and claimed and it is distinguishable from the prior art in this particular combination of all of its structures, construction, functions, features and varied adaptability to different situations and applications as specified.

I claim:

1. An improved electric fencing system that is readily and easily adaptable in the mater of being able to administer an appropriately sized and prescribed electric shock to animals of all sizes and types ranging from creatures as small as a slug or snail to birds and rodents and large livestock and wild animals such as horses, cattle and deer, said electric fence system comprising the following components:
(a) A flat woven tape comprising a plurality of longitudinal conductive threads interwoven with plastic threads, woven and interlaced to form a flat ribbon of various widths and gauges, said widths and gauges are sized according to what size and type of creature or animal the tape is intended to control.
(b) Said conductors being laced into two distinct electrically oppositely biased groups running parallel with each other, longitudinally with the ribbon, side by side and comprehensively exposed on the same side of the flat tape which we will call the face of the tape, and that can be energized with varied voltages, high or low and AC or DC as determined by the type and size of animal needing control and separated by a non-conducting insulating zone also sized according to the animal needing controlled, said design will provide an electrical shock to the animal or creature when both groups of electrical conductors are touched simultaneously.
(c) Said electric fence ribbon to be manufactured in many colors that are intended to safely highlight it, blend it into its surroundings, designer compliment or match the decor.

2. An improved method of installing the electric fence system as disclosed in claim #1 comprising of the following components:
(a) Said flat ribbon as outlined in claim 1 to be manufactured with an electrically insulating, non conducting, waterproof and weatherproof adhesive tape backing used to adhere said electric fence ribbon to many selected surfaces and insulate the electrically charged conductors from conducting electricity to any surface it maybe mounted too and that leaves the face of the electric fence ribbon exposed to the animal to provide the electrical shock when touched.
(b) Said adhesive backing may embody many different types and systems of manufacture and application, for example, it may be supplied in a peel and stick embodiment or the adhesive could be spray applied or painted to the back of the ribbon during manufacture or installation.

3. An improved electric fence system as disclosed in claim #1 that operates on AC or DC current, high, medium or low voltages as disclosed and comprising of the following elements, methods and systems:
(a) High voltages and AC current will be employed for controlling large animals such as livestock, horses, cattle, deer and the like, said current can be steady or pulsed as controlled by the typical state of the art electric fence energizer as seen and commonly used in the industry.
(b) Medium voltages and AC or DC current will be employed for controlling medium sized animals such as rodents, birds, cats and the like, said current can be steady or pulsed as controlled by the electric fence energizer.
(c) Relatively very low voltages and AC or DC current such as 6 VDC will be employed for controlling very small creatures such as slugs and snails and the like, said current can be steady or pulsed as controlled by the electric fence energizer
(d) The supplied electric fence energizing power, as disclosed in 3 (a) and 3 (b) above, shall be shunted or otherwise fault protected to prevent any danger of electrocution following standards and practices commonly know by those educated in this field.
(e) The supplied electric fence energizing power, as disclosed in 3 (a), 3 (b) and 3 (c) above, shall be shunted or otherwise fault protected to prevent any excessive or unnecessary current flow during times when the ribbon maybe wet, as when it is raining, following standards and practices commonly know by those educated in this field.
(f) A terminal means of connecting said power to the electric fence tape that provides an electrically biased charge to the tape, hot and ground in an AC configuration or positive and negative in a DC system, to the two electrically potentially differently energized groups of conductors that are comprehensively exposed on the face of the tape as disclosed in claim #1.
